(19) United States
(12) Patent Application Publication
(10) Pub. No.: US 2016/0340187 A1
(43) Pub. Date: Nov. 24, 2016

(54) STEAM METHANE REFORMING REACTOR WITH HYDROGEN SELECTIVE MEMBRANE

(71) Applicant: KING FAHD UNIVERSITY OF PETROLEUM AND MINERALS, DHAHRAN (SA)

(72) Inventors: SYED AHMAD MOHAMMAD SAID, DHAHRAN (SA); ESMAIL MOHAMED ALI MOKHEIMER, DHAHRAN (SA); SHAKEEL AHMED, DHAHRAN (SA); MOHAMMED WASEEUDDIN, DHAHRAN (SA)

(21) Appl. No.: 14/715,526

(22) Filed: May 18, 2015

(51) Int. Cl. C01B 3/38; B01J 19/24

(52) U.S. Cl. CPC C01B 3/38; B01J 19/2415; C01B 2203/0233; C01B 2203/0805; C01B 2203/1241; B01J 2219/00144; B01J 2219/24

(57) ABSTRACT

The steam methane reforming reactor includes a substantially cylindrical housing or shell and a tube disposed concentrically within the substantially cylindrical shell. The tube includes one or more catalysts. A hydrogen selective membrane extends through a central portion of the tube. The hydrogen selective membrane can be formed from a hydrogen selective material such as a palladium alloy. The membrane defines a central passage or permeate zone. A feed zone including the catalyst extends around the permeate zone. A sweep gas, such as air, nitrogen or the like, may be injected in the permeate zone, via an inlet, and pass through the permeate zone, exiting via an outlet. An annular heated fluid passage is defined between an outer surface of the tube and an inner surface of the substantially cylindrical housing or shell. A heating medium may be injected into the heated fluid passage to pass therethrough.

### BACKGROUND OF THE INVENTION

1. Field of the Invention

The present invention relates to the production of hydrogen, and particularly to a steam methane reforming reactor using a hydrogen selective membrane to enhance hydrogen production.

2. Description of the Related Art

In recent years, there has been a large amount of interest in the usage of hydrogen as a fuel source, due to its potential advantages over hydrocarbon fuels, namely its clean combustion characteristics and higher calorific value. Hydrogen may be commercially produced by a number of different methods, such as electrolysis, steam methane reforming, auto thermal reforming, partial oxidation reforming, extensions of these processes and the like. Hydrogen production via electrolysis is a relatively expensive method due to high production costs, specifically in terms of the electricity requirements. Other processes use hydrocarbons as the main reactant for hydrogen production. Among these methods, the steam methane reforming (SMR) process is the cheapest, oldest and most widely used method for the worldwide commercial production of hydrogen. Steam reforming is, in industrial practice, typically carried out in reactors (referred to as “steam reformers”), which are essentially fired heaters with catalyst-filled tubes placed in the heater. The inlet feed is methane and steam (along with some traces of hydrogen), which enter from one end of the tube and leave as syngas at the other end, following the endothermic steam methane reforming reaction. Specifically, steam methane reforming (SMR) uses an external source of hot gas to heat tubes in which the catalytic reaction takes place that converts steam and lighter hydrocarbons, such as methane, into hydrogen and carbon monoxide (i.e., syngas). The carbon monoxide syngas reacts further to give more hydrogen and carbon dioxide in the reactor. The carbon oxides are removed before use by means of pressure swing adsorption (PSA) with molecular sieves for the final purification. The PSA works by adsorbing impurities from the syngas stream to leave a pure hydrogen gas.

This process may also be carried out in heat exchange reformers, where the heat required for the reaction is supplied predominantly by convective heat exchange. The tubes are filled with the catalyst and the heat required for the reaction is typically supplied by a flue gas, process gas or any other suitable supply of hot gas. The heat and mass balance is considered only on the process side (i.e., the tube side), thus presenting no difference between heat exchange reforming and fired tubular reforming. The process schemes differ only in the amount of latent heat in the flue gas or process gas and the way in which this heat is used.

Thus, a steam methane reforming reactor with a hydrogen selective membrane solving the aforementioned problems is desired.

### SUMMARY OF THE INVENTION

The steam methane reforming reactor includes a substantially cylindrical housing or shell and a tube disposed concentrically within the substantially cylindrical shell. A hydrogen selective membrane extends through a central portion of the tube. The hydrogen selective membrane can be formed from a hydrogen selective material such as a palladium alloy or the like. The hydrogen selective membrane defines a central passage or permeate zone. A feed zone is defined by a space between an outer surface of the hydrogen selective membrane and an inner surface of the shell. The feed zone in the tube includes one or more catalysts, such as nickel, magnesium aluminate (MgAl₂O₄) or the like. The feed zone surrounds the permeate zone and receives reactant gases for methane conversion. A sweep gas, such as air, nitrogen or the like, may be injected in the permeate zone, via an inlet, and pass through the permeate zone, exiting via an outlet. An annular heated fluid passage is defined between an outer surface of the tube and an inner surface of the substantially cylindrical housing or shell. A heating medium, e.g., molten salt, may be injected into the heated fluid passage to pass therethrough and convectively heat reactant gases flowing through the feed zone.

These and other features of the present invention will become readily apparent upon further review of the following specification.

### BRIEF DESCRIPTION OF THE DRAWINGS

FIG. 1 is a side sectional view of a steam methane reforming reactor with a hydrogen selective membrane according to the present invention.

FIG. 2 is a cross-sectional view of the steam methane reforming reactor with a hydrogen selective membrane of FIG. 1, taken along sectional cut line 2-2.

FIG. 3 diagrammatically illustrates an alternative embodiment of the steam methane reforming reactor with a hydrogen selective membrane.

FIG. 4 is a graph showing a comparison of methane conversion (%) as a function of temperature between the present steam methane reforming reactor with a hydrogen selective membrane and a simulated, conventional packed bed shell-and-tube type heat exchange reformer.

Similar reference characters denote corresponding features consistently throughout the attached drawings.

### DETAILED DESCRIPTION OF THE PREFERRED EMBODIMENTS

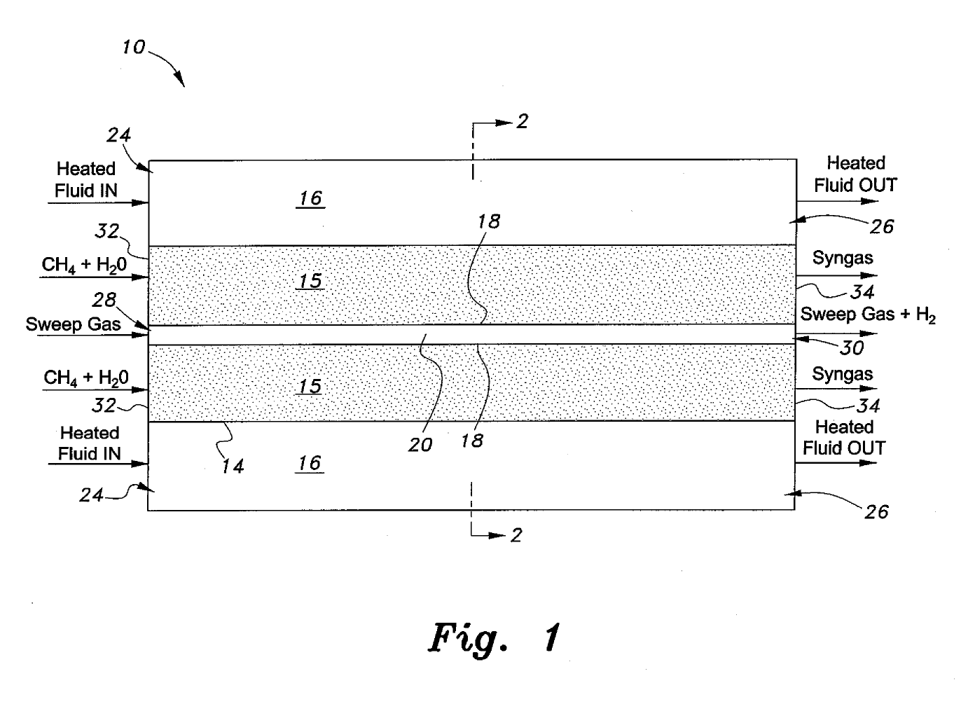

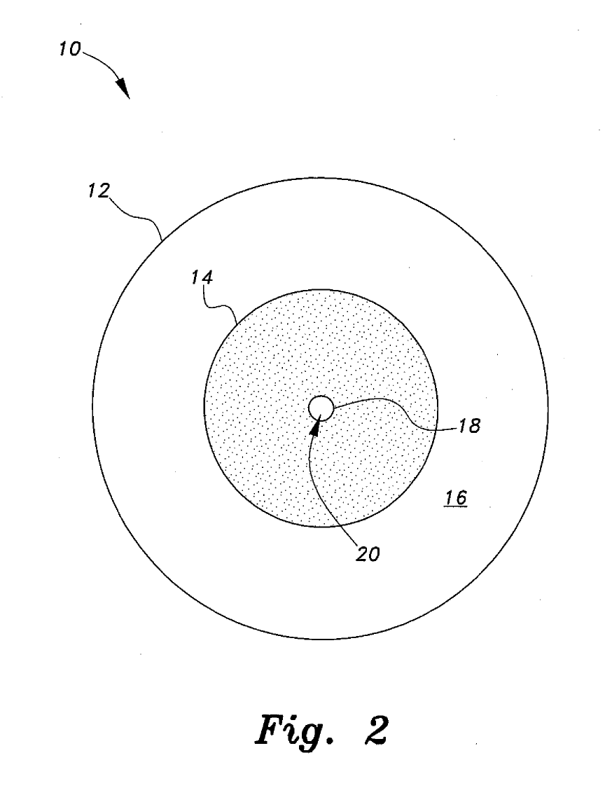

As shown in FIGS. 1 and 2, the steam methane reforming reactor with a hydrogen selective membrane 10 uses steam methane reforming to produce hydrogen. The steam methane reforming reactor includes a substantially cylindrical housing or shell 12 and a tube 14 having an annular cross section disposed concentrically within the substantially cylindrical shell 12. The tube 14 includes one or more catalysts, such as nickel, magnesium aluminate (MgAl₂O₄) or the like. A hydrogen selective membrane 18 extends through a central portion of the tube 14. The hydrogen selective membrane 18 can be formed from a hydrogen selective material such as a palladium alloy or the like. The membrane defines a central passage or permeate zone 20. A feed zone 15 including the catalyst extends around the permeate zone 20 between an outer surface of the membrane 18 and an inner surface of the tube 14. A sweep gas, such as air, nitrogen or the like, may be injected in the permeate zone 20, via an inlet 28, and pass through the permeate zone 20, exiting via an outlet 30. It should be understood that the sweep gas may be injected, under pressure, into the central passage 20 by any suitable means, such as a pump, connection to an external pressurized supply, or the like. An annular heated fluid passage 16 is defined between an outer surface of the tube 14 and an inner surface of the substantially cylindrical housing or shell 12. A heating medium or heating fluid, e.g., molten salt, may be injected into the heated fluid passage 16 to pass therethrough.

In operation, the molten salt and/or other heating medium gets heated by circulating through a series of solar parabolic troughs to a temperature of about 600° C. Exhaust from a gas turbine unit, flue gas, and/or any other hot gas, may also be injected into the heated fluid passage 16 with temperatures ranging from about 370° C. to about 650° C. Reactant gases for reforming, i.e., a mixture of steam and methane (CH₄), are injected into an inlet end 32 of the tube 14 including the catalyst. The tube 14 is convectively heated by the heating medium flowing through the heated fluid passage 16 and methane conversion takes place in the feed zone 15. The hydrogen formed during the methane conversion in the feed zone 15 is permeated through the hydrogen selective membrane 18 and high purity hydrogen is obtained. Preferably, the membrane 18 is positioned at a core or central portion of the tube 14. At least one syngas, such as carbon monoxide or carbon dioxide, exits the tube 14 through an outlet end 34 thereof, and a mixture of the sweep gas and the hydrogen gas exits the central passage 20 through outlet 30. It should be understood that the mixture of steam and methane may be injected, under pressure, into the inlet end 32 of the tube 14 by any suitable means, such as a pump, connection to an external pressurized supply, or the like. It should be further understood that the heated fluid may be injected, under pressure, into the inlet 24 of annular heated fluid passage 16 by any suitable means, such as a pump, connection to an external pressurized supply, or the like, with the heated fluid exiting through outlet 26.

When compared to conventionally used systems, higher conversions of methane are obtainable using the present reactor. This can be due to the equilibrium shifts which occur due to the removal of hydrogen from the product stream.

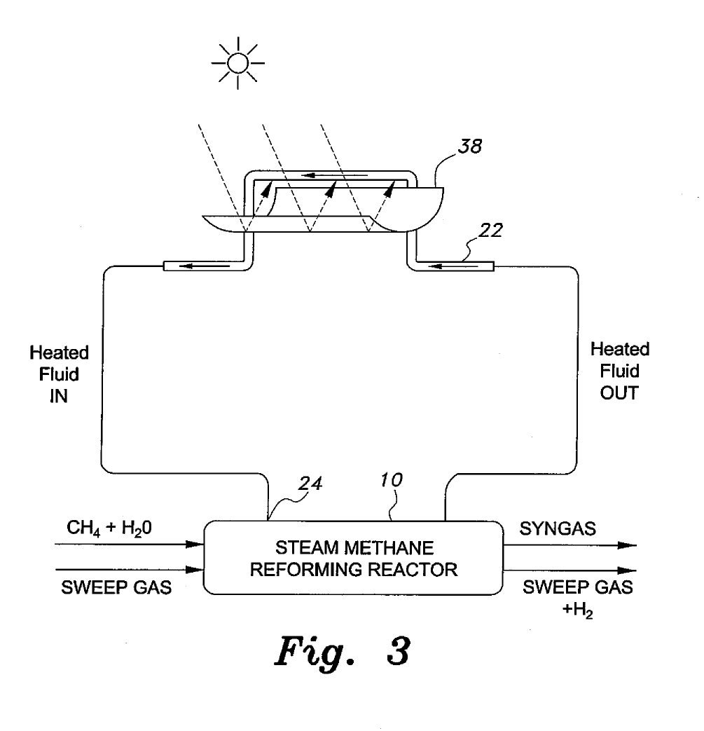

In an embodiment, as shown in FIG. 3, a conduit 22 extends between inlet 24 and outlet 26 of the annular heated fluid passage 16 for recycling the heated fluid. This allows the heated fluid to be heated in the conduit 22, external to the substantially cylindrical housing 12 of the steam methane reforming reactor with a hydrogen selective membrane 10. The heated fluid may be heated in the conduit 22, external to the housing 12, by the solar parabolic trough 38, for example. As a further alternative, a volume of auxiliary hydrogen may also be injected into the inlet end 32 of the tube 14 with the mixture of steam and methane.

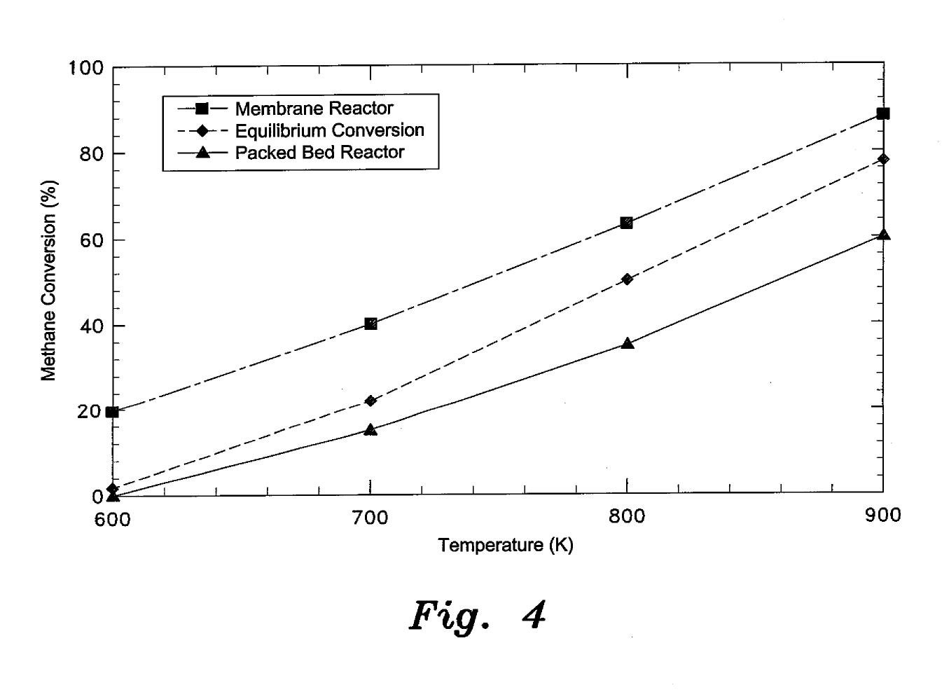

In order to test the efficacy of the steam methane reforming reactor with a hydrogen selective membrane 10, a simulation study was performed using a packed bed shell-and-tube type heat exchange reformer without a membrane for different ranges of inlet air temperatures (i.e., varying temperatures produced by a solar facility for the heated fluid, such as the solar parabolic trough 38 of FIG. 3) to determine the conversion rates of methane. The inlet feed consisted of steam, methane and auxiliary hydrogen, with a molar steam to methane ratio of 3:1 and a molar hydrogen to methane ratio of 0.122. The pressure of the mixture gas was set to 1.0 bar. The mass flow rate of heated air was set corresponding to a Reynolds number of 35,000. FIG. 4 shows a comparison of methane conversion (%) as a function of temperature between the steam methane reforming reactor with a hydrogen selective membrane 10 and the simulated, conventional packed bed shell-and-tube type heat exchange reformer (without a hydrogen selective membrane). It can be seen that methane conversion at low temperatures is below the equilibrium conversion for the conventional packed bed shell-and-tube type heat exchange reformer, whereas conversion is greatly enhanced, when compared against equilibrium, for the present steam methane reforming reactor with a hydrogen selective membrane. The low methane conversion at lower temperatures for the conventional reactor can be explained by the slow reaction kinetics of the process at low temperatures.

Because of the enhanced methane conversion of the present steam methane reforming reactor with a hydrogen selective membrane 10 at low temperatures, the reactor may be used in conjunction with heating systems which operate at relatively low temperatures, such as the solar parabolic trough 38 of FIG. 3. Accordingly, as described above, the solar parabolic trough 38 can be used to heat the heating fluid. The working temperatures of palladium membranes are typically on the order of 300-700° C., thus making them well suited for the temperatures generated by solar parabolic troughs. As noted above, the hydrogen formed during the steam methane reforming process is permeated through the membrane 18 and high purity hydrogen is obtained. The membrane 18 at the core of the tube 14 provides the advantage of achieving methane conversion at higher rates when compared to a conventional shell-and-tube heat exchange reformer without a membrane. These higher conversions of methane can be due to the equilibrium shift which occurs due to the removal of a product (i.e., hydrogen) from the product stream. Higher conversions of methane are beneficial, especially when working at lower temperatures on the order of approximately 650° C., which is far from the practiced temperature range (˜850-950° C.) for conventional steam methane reforming.

Today's world is rapidly moving towards green solutions for energy generation. Solar parabolic trough technology is both efficient and cost effective. Solar parabolic troughs, however, do not generate the temperatures required for the conventional steam methane reforming process, since the process is highly endothermic. The temperatures obtained by parabolic troughs are typically on the order of 300-600° C. The present steam methane reforming reactor with hydrogen selective membrane provides a significantly higher conversion rate of methane in the tube side of the reformer. The hydrogen selective membrane of the present heat exchange reformer allows hydrogen to be removed from the products such that the reaction tends to proceed toward the product side. Thus, high reaction temperatures are not required. This allows for higher methane conversion rates at low temperatures.

It is to be understood that the present invention is not limited to the embodiments described above, but encompasses any and all embodiments within the scope of the following claims.

We claim:

1. A steam methane reforming reactor with hydrogen selective membrane, comprising:
a substantially cylindrical housing;
a tube positioned concentrically within the cylindrical housing;
a hydrogen selective membrane extending through a central portion of the tube, the membrane defining a permeate zone through which a sweep gas may flow,
a heated fluid passage defined by a space between an outer surface of the tube and an inner surface of the substantially cylindrical housing, the heated fluid passage being configured to allow a heated fluid to pass therethrough;
a feed zone defined by a space between an inner surface of the tube and an outer surface of the hydrogen selective membrane, the feed zone being configured to allow reactant gases to pass therethrough; and
a catalyst dispersed in the feed zone.

2. The steam methane reforming reactor with hydrogen selective membrane as recited in claim 1, wherein the catalyst is selected from the group consisting of nickel and magnesium aluminate.

3. The steam methane reforming reactor with hydrogen selective membrane as recited in claim 2, wherein the hydrogen selective membrane comprises a palladium alloy.

4. The steam methane reforming reactor with hydrogen selective membrane as recited in claim 1, further comprising:
a conduit extending between an inlet and an outlet of the annular heated fluid passage for recycling the heated fluid.

5. A solar parabolic trough and steam methane reforming reactor with hydrogen selective membrane system, comprising:
solar parabolic trough and steam methane reforming reactor with hydrogen selective membrane system including:
a substantially cylindrical housing;
a tube positioned concentrically within the cylindrical housing;
a hydrogen selective membrane extending through a central portion of the tube, the membrane defining a permeate zone through which a sweep gas may flow,
a heated fluid passage defined by a space between an outer surface of the tube and an inner surface of the substantially cylindrical housing, the heated fluid passage being configured to allow a heated fluid to pass therethrough;
a feed zone defined by a space between an inner surface of the tube and an outer surface of the hydrogen selective membrane, the feed zone being configured to allow reactant gases to pass therethrough;
a catalyst dispersed in the feed zone;
a conduit extending between an inlet and an outlet of the annular heated fluid passage for recycling the heated fluid; and
one or more solar parabolic troughs external to said substantially cylindrical housing, the solar parabolic trough being configured for heating heated fluid flowing in the conduit.

6. The solar parabolic trough and steam methane reforming reactor with hydrogen selective membrane system, as recited in claim 5, wherein the catalyst is selected from the group consisting of nickel and magnesium aluminate.

7. The solar parabolic trough and steam methane reforming reactor with hydrogen selective membrane system, as recited in claim 5, wherein the hydrogen selective membrane comprises a palladium alloy.

8. A method for producing hydrogen by steam methane reforming, comprising
providing the solar parabolic trough and steam methane reforming reactor with hydrogen selective membrane system recited in claim 5;
heating a heating medium in the one or more solar parabolic troughs to provide a heated medium;
injecting the heated medium into the heated fluid passage;
injecting steam and methane (CH₄) into the feed zone;
convectively heating the feed zone by heat flowing through the heated fluid passage;
reacting the steam and methane (CH₄) in the feed zone to produce a product stream including hydrogen; and
using the hydrogen selective membrane to collect hydrogen from the product stream.
